(19) United States
(12) Patent Application Publication
(10) Pub. No.: US 2025/0383709 A1
(43) Pub. Date: Dec. 18, 2025

(54) METHOD FOR GENERATING AN OPTIMIZED ON-SCREEN KEYBOARD FOR A DEVICE, COMPUTER-READABLE STORAGE MEDIUM AND DEVICE FOR A SUPPORTED COMMUNICATION

(71) Applicant: Curly Cube GmbH, Stuttgart (DE)

(72) Inventor: Kolja Böger, Düsseldorf (DE)

(21) Appl. No.: 19/233,481

(22) Filed: Jun. 10, 2025

(30) Foreign Application Priority Data
Jun. 12, 2024 (DE) 102024116477.8

(51) Int. Cl. G06F 3/01; G06F 3/0481; G06F 3/04842; G06F 40/166; G06F 40/274

(52) U.S. Cl. CPC G06F 3/013; G06F 3/0481; G06F 3/04842; G06F 40/166; G06F 40/274

(57) ABSTRACT

The present invention relates to a method for generating an optimized on-screen keyboard for a device (20), in particular device for a supported communication, wherein the device is formed to display an on-screen keyboard (1), which can be operated by a user by means of eye control, wherein the method has the following steps: (a) displaying an on-screen keyboard (1), which has a plurality of buttons, on the device (20); (b) receiving at least one user input with regard to the on-screen keyboard (1), in particular focusing on a button by means of eye control; (c) determining context information, at least based on the user input; (d) generating a modified on-screen keyboard based on the context information, wherein the modified on-screen keyboard includes at least one modified information and/or action element, which is arranged in a focus area of the user; and (e) displaying the modified on-screen keyboard on the device (1). What is further specified is a computer-readable storage medium, which includes instructions, which prompt at least one processor to implement the method as well as a corresponding device, in particular for a supported communication.

The invention relates to a method for generating an optimized on-screen keyboard for a device, in particular for a device for a supported communication. The invention further relates to a corresponding computer-readable storage medium as well as a corresponding device.

People who are unable to speak and move due to extensive motor skill limitations (e.g., due to ALS or infantile cerebral palsy), often use special devices for a supported communication. Voice-controlled computers, which detect the gaze position of the user on an on-screen keyboard and which make it possible to select letters by prolonged focusing the gaze on the respective button by means of a connected eye tracking camera, is one example for such devices.

However, the devices for a supported communication known from the prior art are in need of improvement in various respects.

Even though voice-controlled computers with on-screen keyboards, which have enlarged buttons, in order to simplify the input for the user are known, users generally only reach a slow input pace and/or a high error rate. Wrong inputs on the on-screen keyboard can also occur due to the inaccuracy, which cannot be avoided completely, during the detection of the gaze position by means of eye tracking cameras. This has the result that users can often not participate in conversations or cannot participate in a satisfactory manner, in spite of the use of the communication aid.

It is the object of the present invention to specify a method for generating an optimized on-screen keyboard for a device, in particular a device for a supported communication. The optimized on-screen keyboard is to in particular provide for a higher input speed during the operation by means of eye tracking camera of the device. It is the further object to specify a corresponding device and a computer-readable storage medium.

This object is solved by means of a method according to claim 1, a computer-readable storage medium according to claim 13 as well as by means of a device according to claim 14.

The object is solved in particular by means of a method for generating an optimized on-screen keyboard for a device, in particular a device for a supported communication. The device is thereby formed to display an on-screen keyboard, which can be operated by a user by means of eye control, and the method has the following steps:
a) displaying an on-screen keyboard, which has a plurality of buttons, on the device;
b) receiving at least one user input with regard to the on-screen keyboard, in particular focusing on a button by means of eye control;
c) determining context information, at least based on the user input;
d) generating a modified on-screen keyboard based on the context information, wherein the modified on-screen keyboard includes at least one modified information and/or action element, which is arranged in a focus area of the user; and
e) displaying the modified on-screen keyboard on the device.

The method according to the invention, based on a user input (for example, focusing on a button by means of eye control) and context information, which is determined based on the user input (for example, a list of previous user inputs), generally makes it possible to specify a modified on-screen keyboard, which simplifies the input process for the user.

The modified on-screen keyboard thereby includes at least one information and/or action element. An information element can be, for example, a graphic element, which includes a word, a character or the like. An action element can be, for example, a button, which the user can select just like the other buttons, for instance by focusing. An information and action element can therefore in particular be a button, on which information is displayed and which triggers a corresponding action when triggered, for example, the input of a proposal for a word completion displayed on the button. The information and/or action element can also be a modified button, for example a button for a letter, on which a word proposal is additionally displayed.

It is an essential aspect of the method according to the invention that the at least one information and/or action element is arranged in a focus area of the user. An area on the screen of the device, in particular on the on-screen keyboard displayed thereon, on which the user focusses his/her gaze during the ongoing input process, can be perceived as focus area thereby. When inputting letters on an on-screen keyboard, the focus area of the user can in particular lie on the respective button, on which the user currently focusses, in order to continue the word. The user thereby does not perceive elements outside of the focus area or at least perceives them only to a very limited extent (foveal vision). In other words, during the input process, the user essentially perceives a section (focus area) of the on-screen keyboard, which moves from button to button according to the word to be input.

The advantages of the above-described approach according to the invention become apparent especially in comparison with conventional on-screen keyboards, in the case of which word proposals are arranged, for example, above the on-screen keyboard. In that, according to the invention, the information and/or action element is arranged in the area which the user looks at (i.e., in the focus area), the user inevitably perceives the additional element intuitively during the input process, without having to additionally search for it on the screen area;
the user can (in the case of an action element) directly trigger the additional element in the focus area, without looking away from the focus area, in order to activate a separate button;
the likelihood is minimized that the user does not utilize the additional element because he/she overlooks it due to his/her “tunnel vision”.

The optimized on-screen keyboard generated in this way provides for a comfortable and intuitive operation of a device via eye control, which is designed for idiosyncrasies of human perception. A high input speed and low error rate can be achieved thereby.

In the practical use of the method according to the invention, users and experts confirmed a more than 1.5 times higher communication speed and more lively discussion participation.

In one embodiment, step c), i.e., the determination of context information, comprises an evaluation of an input prefix, which is specified by a sequence of previous user inputs and the (current) user input. Step d) thereby comprises the following steps:
generating at least one word proposal based on the input prefix;
assigning the at least one word proposal to a button of the on-screen keyboard, wherein the button displays a following letter with regard to the input prefix and the word proposal.

In step d), the at least one word proposal is thereby displayed as information and action element within the assigned button.

According to this embodiment, the input prefix displays context information as list of previous user inputs including the current user input, which is used to generate the modified on-screen keyboard.

The input prefix can thereby in particular be a sequence of user inputs since a last space or punctuation mark, which starts with a letter. Alternatively, however, the input prefix can also start with a different character, in particular a space of punctuation mark.

After the input of the letters “he”, for example, which form an input prefix (more precisely: word prefix) with regard to the word “today” (German: “heute”), a corresponding word proposal “heute” can be determined and can be displayed to the button of the following letter “u”. A following letter can thereby be understood as that letter, which stands immediately after the input prefix in the word proposal.

In that the word proposal is displayed within the button of the following letter, the user will inevitably perceive the word proposal because after inputting the last character of the word prefix, his/her gaze intuitively wanders towards the following letter, in order to continue the input of the word.

A plurality of word competitions is preferably generated, for example word proposals for up to eight different following letters. These following letters can thereby be highlighted in color in the modified on-screen keyboard.

Those following letters, which are assigned to a word proposal, can furthermore be triggered in the modified on-screen keyboard by means of eye control for a shorter dwell time than other buttons or letters, respectively, of the on-screen keyboard. In this way, the user can quickly and easily accept the word proposals in the input process because only a comparatively short focusing on the following letter button is required. This increases the input speed and simplifies the operation by means of eye control.

In a further embodiment, step c), i.e., the determination of context information, comprises the followings steps:

c1) evaluating a root word based on a sequence of previous user inputs;

c2) generating at least one word proposal, which specifies an inflection of the root word, in particular with regard to person, mode and/or gender;

c3) assigning the at least one word proposal to a button of the on-screen keyboard, wherein the button displays a last or penultimate letter of the word proposal.

In step d), the at least one word proposal is illustrated within the assigned button.

This embodiment simplifies the input of specific inflections of words (e. g., verbs, adjectives, pronouns), in that inflections belonging to a root word are generated and are displayed as word proposals in an assigned button. It is not required in this way to accept a word proposal of the basic form (e. g., “can”—German: “können”) and to manually correct it to the desired inflection (e.g., “could”—German: “könntest”).

Unlike in the previous embodiment, the word completions corresponding to the inflections are thereby not displayed in the following letter but in a penultimate or last letter of the word completion. In the German language, users can, for the most part, associate inflections well via the last or penultimate letter thereof. This makes it possible for the user to quickly and intuitively find the desired inflection on the modified on-screen keyboard because the inflection is essentially characterized by the respective last or penultimate letter, in particular by letters, such as “s”, “n”, “e”, “t”, “r” or “m”. These letters characterize the respective inflections in the German language.

According to this embodiment, the buttons, which include the corresponding word proposals, can also be marked in color and/or can have a shorter dwell time, as it is described above in combination with the previous embodiment. All buttons, which include inflections as word proposals, can in particular have a certain color (e.g., green), which differs from the color of buttons without word proposal and buttons with word proposals, which do not specify an inflection. In this way, the user can simply identify the different inflection word proposals as group of alternatives, from which he/she can select an inflection.

In a further embodiment, the method further comprises the following steps:
detecting that, by means of eye control, the user focusses on a button, in which a word proposal is displayed;
providing a completion button in the modified on-screen keyboard, preferably in a lower area thereof, wherein the completion button displays the word proposal and is formed to accept the word proposal upon selection.

This embodiment allows that the user can easily and quickly accept a desired word proposal, which is displayed, for example, within a letter button, in that he/she directs his/her gaze position at the separate completion button.

The arrangement of the completion button in the lower area of the modified on-screen keyboard is advantageous thereby because the eye movement for a downwards “gaze jump” is physically possible more easily and more quickly than other movements. Alternatively, however, the button can also be arranged in a different area of the modified on-screen keyboard, which the user can reach more easily.

In a further embodiment, the method is characterized in that
a plurality of word proposals is generated;
the method further comprises a determination of a priority of the respective word proposal; and
that word proposal, which has the highest priority among all word proposals, which are assigned to the button, is displayed in a respective button, in which a word proposal is displayed.

This embodiment thus deals with the problem that more word proposals than can be displayed on an on-screen keyboard, can generally be determined, in particular when the word proposals—as explained above—are assigned to respective following letters and are to be displayed within the buttons thereof. In that word proposals are prioritized according to this embodiment, that word proposal, which, as expected, is most helpful for the user in the current context, can be displayed within the buttons.

The priority of a word proposal can thereby in particular be determined as a function of a usage frequency in a language, wherein the usage frequencies of the respective word proposals can be stored in a database, and the method comprises the querying of a usage frequency from the database. Alternatively or additionally, the database can include the user-specific usage frequencies, i.e., usage frequencies, which have been determined on the basis of previous inputs by the user.

Alternatively or additionally, the can priority be determined on the basis of a discussion situation, wherein the method for identifying a discussion situation detects, for example, sound, image and/or position data from corresponding sensors and classifies said data into one of several discussion situations. Respective priorities can thereby be assigned to the words or word proposals, respectively, for each of the discussion situations.

Alternatively or additionally, the word length can be considered in the prioritization factor. For example, short words can be preferred compared to longer words, in order to simplify an input process, in the case of which the word completion of a short word is selected initially, and individual letters are supplemented subsequently. Such an input process can simplify the input compared to a situation, in which a word completion of a long word is accepted, from the end of which individual letters have to be removed.

It goes without saying that, based on the above-mentioned priority criteria, a priority of the word proposal can be predefined individually or also based on a combination of the priority criteria. For this purpose, the individual priority criteria per se can be assigned to weighting factors.

In a further embodiment, the method is characterized in that the user input comprises the focusing on a delete button, and the method further comprises the following steps:
determining a word, which will at least be partly deleted when continuing to focus on the delete button; and
displaying the word within the delete button.

In response to the input of text by means of an on-screen keyboard, the delete button is used to delete individual characters or words at the end of the input text. The user hereby triggers the delete button until the desired characters or words have been removed.

According to the above-described embodiment, the word, the letters of which are deleted by means of the momentary focusing on the delete button, is displayed to the user within the delete button. Exactly that information, which he/she requires for his/her decision whether the delete button is to still be activated, is thus displayed to the user within his/her current focus area, i.e., within the delete button itself. It is in particular not required for the user to direct his/her gaze position away from the delete button and to direct it at a text field, in order to check whether a sufficient number of characters has already been deleted.

In a further embodiment, step c), i.e., the determination of context information, further comprises the following steps:
detecting environmental data, in particular voice, image and/or position data, from at least one sensor;
assigning the environmental data to at least one environment, in particular discussion context, discussion partner and/or location.

Step d) thereby comprises the modification of at least one button based on the environmental data.

It is desirable in particular among users of devices for a supported communication to be able to quickly use word proposals, which they require in the concrete discussion situation. The language behavior, in particular with respect to the usage frequency of certain words, is thereby often determined by the concrete discussion situation. For typical discussion situations at work or at school, for example, a different vocabulary is often used than in private discussions. Even in private discussions, the discussion style and thus the frequently used words can be different, depending on the discussion partner.

According to the above embodiment, environmental data is detected and is classified into one of several predefined environments, in order to generate a modified on-screen keyboard with context-dependent word proposals. This can take place, for example, in that
sound data is detected and last spoken utterances from a current discussion are analyzed via speech recognition;
image data is detected and a facial recognition is carried out, in order to identify discussion partners;
position data, e.g., GPS data, is detected, in order to identify a location of the user;
words and utterances are detected, which suggest a current location (e.g., workplace, doctor, at home).

Based on the classification of the environment, as already described above in connection with the corresponding embodiment, in particular priorities or usage frequencies of word proposals can be predefined.

In a further embodiment, at least one language model, in particular a large language model (LLM), is used for
assigning the environmental data to at least one environment; and/or
generating word proposals, in particular based on the environment.

The at least one LLM can thus in particular be used to generate word proposals, which are provided to the user in the modified on-screen keyboard. A sequence of related word proposals, which form a complete sentence, can likewise be generated.

By using an LLM, the quality or applicability, respectively, of the generated proposals can be further optimized for the user, so that, for example,
words matching the topic of the current discussion,
responses to utterances and questions by the discussion partners,
words and utterances, which relate to topics, which have been discussed in the past with people who are present,
   are generated and are provided in the modified on-screen keyboard, which is generated according to the invention.

For example, the sound and/or image data as described above can, for this purpose, initially be converted into text data and can subsequently be processed by means of the LLM.

In a possible implementation, a single LLM is used hereby, which is formed to provide word proposals based on environmental data.

In another possible implementation, two LLMs can be used hereby, wherein a first LLM is formed to classify the detected environmental data into an (abstract) environment (e.g., school, work, personal discussion, etc.), and a second LLM is formed to generate corresponding word proposals based on the environment.

In a further embodiment, step c) comprises a detection of a dwell time on a first button, and the method further comprises the following steps:
determining whether the dwell time exceeds a preselection threshold value;
if the dwell time exceeds the preselection threshold value, generating the modified on-screen keyboard in such a way that the latter includes a second button, wherein the second button is configured to trigger an action, which is associated with the first button, in particular the input of a letter, which is displayed on the first button.

The second button is thereby larger, preferably at least twice as large, as the first button, and is preferably arranged in a lower area of the modified on-screen keyboard. The arrangement of the second button in the lower area of the modified on-screen keyboard is advantageous thereby because the eye movement for a downwards “gaze jump” is physically possible more easily and more quickly than different movements. Alternatively, however, the second button can also be arranged in a different area of the modified on-screen keyboard, which can be easily reached by the user.

While an eye control operating concept, in the case of which a button is triggered as soon as the dwell time on the button exceeds a trigger threshold value (e.g., 1 second), is well suited for users, who can control their gaze position comparatively well, this is associated with difficulties for other user groups. This applies in particular to users, whose gaze position is unstable, for example due to unintentional head movements due to cerebral palsy, and thus often unintentionally wanders away from the targeted button prior to the expiration of the trigger threshold value. A reduction of the trigger threshold value (e.g., to 300 ms), in contrast, would lead to unintentional triggering processes.

The above-described embodiment allows for the preselection of one of the buttons of the on-screen keyboard (“first button”) for triggering purposes, in that the gaze position on the button is held for the length of a dwell time, which exceeds a preselection threshold value. The preselection threshold value can thereby in particular be predetermined to be comparatively short, for example, 100 ms to 500 ms, and can be lower than a trigger threshold value as described above.

After focusing on a button for at least the duration of the preselection threshold value (i.e., after the “preselection”), a second, larger button is provided in the modified on-screen keyboard according to the described embodiment (for example in a lower screen area), which second button is configured to trigger an action, which is associated with the first button. The triggering of the second button, for example, can effect the input of a letter, which is displayed on the first button. Users can thus bring about the action of the preselected button (“first button”) in that they trigger the second, larger button by means of eye control, which is easier due to the larger dimensions thereof.

The modified on-screen keyboard can in particular be configured for an operating mode, in the case of which the sole focusing on letter buttons and/or other buttons does not directly lead to the usual action (e.g. input of the letter) but only to a preselection of the letter and to the display of the second button, so that the action can be triggered by triggering the second button, as described above.

The described embodiment thus simplifies the operability of the on-screen keyboard, in particular for the above-described user group, and reduces the risk of wrong inputs.

In a further embodiment, one or several buttons of the on-screen keyboard and of the modified on-screen keyboard are triggered by focusing on a respective area (hereinafter: “hitbox”). The hitbox is thereby larger than a visible boundary of the button and surrounds the visible boundary of the button (without it being visible on the on-screen keyboard). All buttons of the on-screen keyboard and of the modified on-screen keyboard can in particular have such a hitbox, which is assigned to them.

This embodiment thus makes it possible that a button is also triggered when the gaze position of the user lies outside of the visible boundary of the button, as long as it is located within the hitbox. This embodiment can thus simplify the input process especially for users, who have difficulties in precisely controlling their gaze position.

The size and/or the position of the hitbox can thereby in particular be predetermined based on context information, in particular an environment, discussion situation or previous user inputs. The hitbox of a button can, for example, be predefined at a value larger than a standard value, when it follows from the context information that the user will select this button with high probability.

In a further embodiment, the method further comprises the following steps:
detecting a speed, with which a gaze position of the user moves over the on-screen keyboard;
modifying a trigger threshold of at least one button of the modified on-screen keyboard based on the speed, wherein the trigger threshold specifies a time, during which the button has to at least be focused on in order to be triggered.

In other words, a speed, with which the gaze of the user moves over the screen of the device or the on-screen keyboard, respectively, is detected according to this embodiment as context information. Respective trigger thresholds of one or several buttons are predefined in the modified on-screen keyboard as a function of the detected speed.

With this approach it is in particular possible to deactivate buttons, as long as the input speed is (too) high, and to activate the buttons only when the input speed lies within a permissible range, wherein the buttons can then be selected as usual by focusing for a specified dwell time. The button can thereby be marked so as to be bordered, as soon as the dwell time starts to run.

The above behavior can be attained by specifying an input speed dwell time profile, in the case of which a dwell time, which is so high that an expiration of the dwell time can virtually not occur, is assigned to input speeds, which lie above a maximum value. This essentially corresponds to a behavior, in the case of which the timing of the dwell time does not even start. The usual dwell time, in contrast, can be assigned to input speeds below the maximum value.

Alternatively, an input speed dwell time profile can be used as basis, in the case of which the respective trigger thresholds (dwell times) are selected proportionally to the detected input speed, so that a higher input speed requires a longer dwell time of a button, before the latter is triggered.

The described embodiment thus helps to prevent wrong inputs, which result when the user moves his/her gaze over the on-screen keyboard too quickly, i.e., in an uncontrolled manner.

In a further embodiment, the detection of the at least one user input comprises a detection of a movement path over the on-screen keyboard and the determination of context information comprises a continuous determination of a current input prefix and corresponding word proposals during the input of the movement path. The word proposals are thereby provided via the modified on-screen keyboard during the input of the movement path.

A movement path can in particular be specified on the on-screen keyboard as list of gaze positions, which have been detected in short time intervals (for example every 10 ms).

The input type according to this embodiment is similar to the “swipe” functionality of touchscreen on-screen keyboards.

Unlike in the case of the already described input mode, in the case of which a user triggers the individual buttons by focusing on the corresponding buttons for a respective minimum period, the corresponding buttons or inputs, respectively, have to initially be determined from the movement path for a movement path. It is generally not sufficient hereby to generate the organized list of all inputs, the buttons of which appear in the movement path because the user also “skims” buttons, which he/she does not intend to select. In this respect, the determined input prefix for the movement path can be perceived as a list of inputs (e.g., letters), of which it can be assumed, based on the movement path, that the user wanted to input them.

This embodiment is preferably combined with one or several of the already described embodiments so that, after a first portion of a movement path as described above has been detected, corresponding word proposals are displayed within buttons, which lie within a current focus area or gaze area, respectively, of the user. The word proposals can hereby in particular refer to the words, which are likely input candidates on the basis of the movement path.

A quick input of letters can be realized on the on-screen keyboard by means of this embodiment. Compared to the conventional “swipe” functionality for touchscreens, in the case of which a word proposal is generated only after input of the complete movement path, the display of word proposals in the focus area, i.e., within the respective buttons, and the continuous generation and display of word proposals during the input of the movement path offers the advantage that the user can already terminate the input of the movement path early, as soon as a correct word proposal is made.

The object is further solved by means of a computer-readable storage medium, which includes instructions, which prompt at least one processor to implement the method as described above when the instructions are executed by means of the at least one processor.

With regard to the computer-readable storage medium, similar advantages and technical effects result as it has been described in combination with the method according to the invention.

The object is further solved by means of a device, in particular for a supported communication, which has the following:
a tablet computer, which is formed to display an on-screen keyboard; and
an eye tracking camera, which is formed to detect a gaze position with respect to the on-screen keyboard.

The tablet computer is thereby formed to receive the gaze position from the eye tracking camera and to carry out the method according to the invention as described above.

In one embodiment of the device according to the invention, the device further has at least one of the following sensors: sound sensor, image sensor, GPS position sensor. The mentioned sensors can in particular be used to detect environmental data, as it has been described in connection with the corresponding embodiment of the method according to the invention.

Similar advantages and technical effects, as it has been described in combination with the method according to the invention, result with regard to the device according to the invention.

It is important to note at this point that the features and the advantages, which can in each case be achieved therewith and which have been described with regard to the method according to the invention, can be applied or transferred, respectively, to the devices according to the invention and vice versa. In the context of the present description of the invention, the components of the devices are concretely formed to carry out the method steps according to the invention. The functions of the above-described components of the devices according to the invention can likewise be applied as method steps of the method according to the invention.

The invention will be described below on the basis of exemplary embodiments, which will be explained in more detail on the basis of the images, whereby:

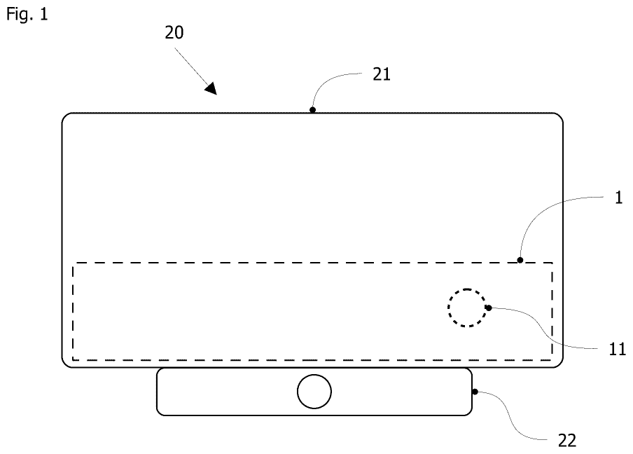

FIG. 1 shows a schematic illustration of a device according to the invention for a supported communication;

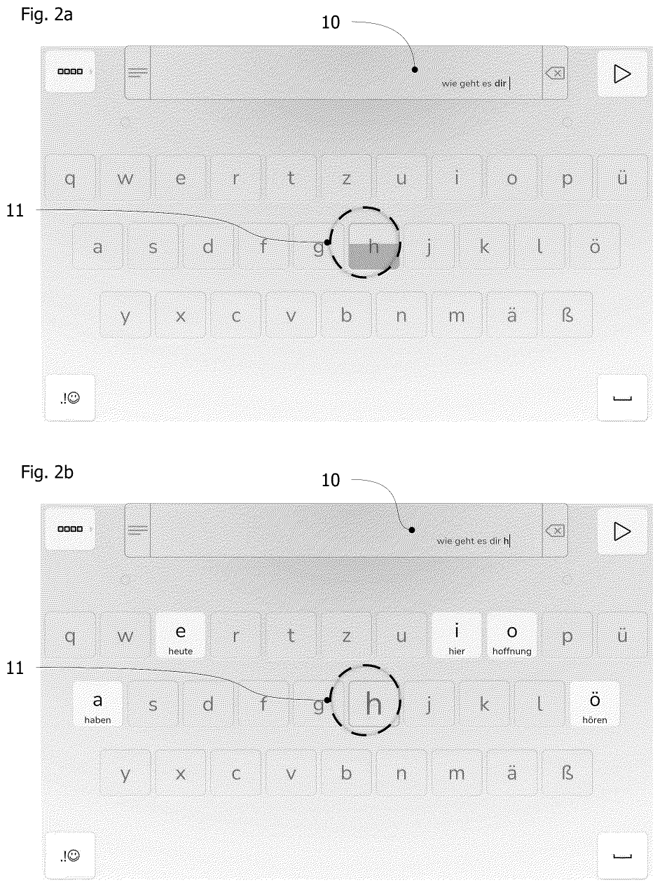

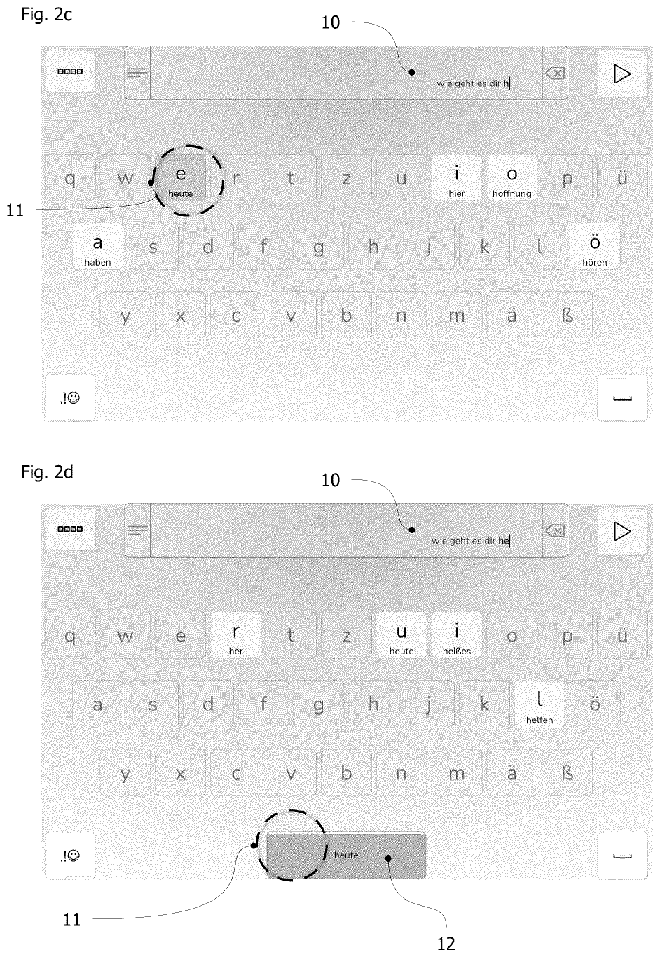

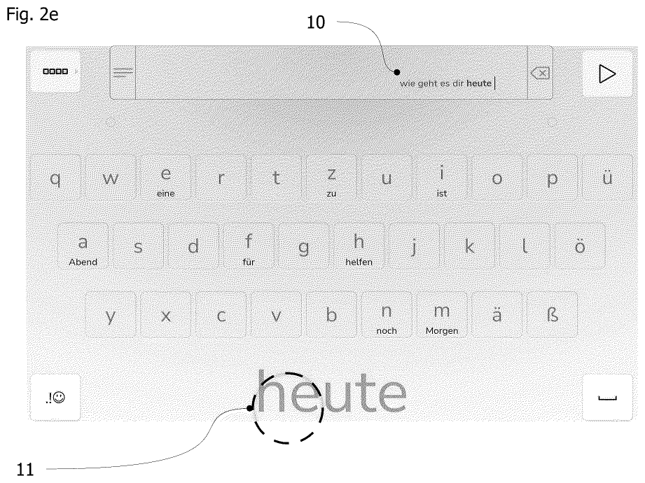

FIGS. 2a-2e show the generation of word proposals in response to the application of the method according to the invention according to a first exemplary embodiment;

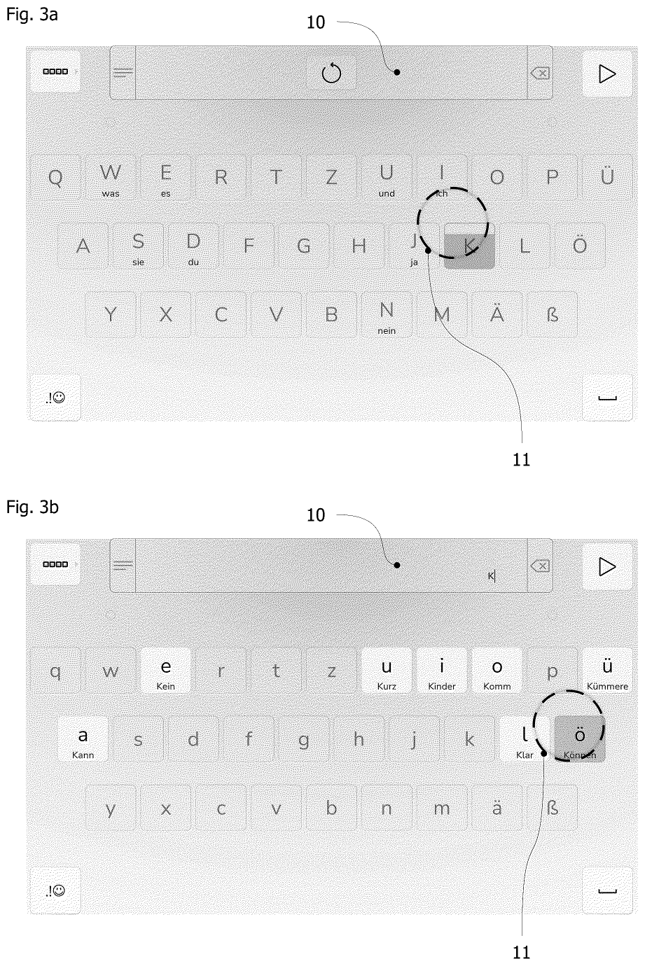

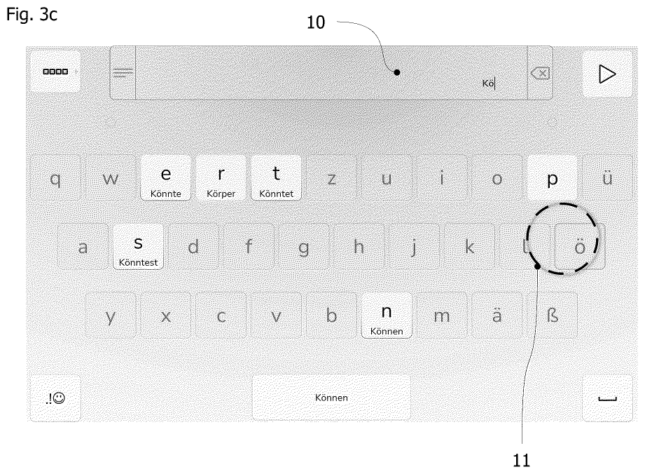

FIGS. 3a-3c show the generation of inflections as word proposals according to a second exemplary embodiment of the method according to the invention;

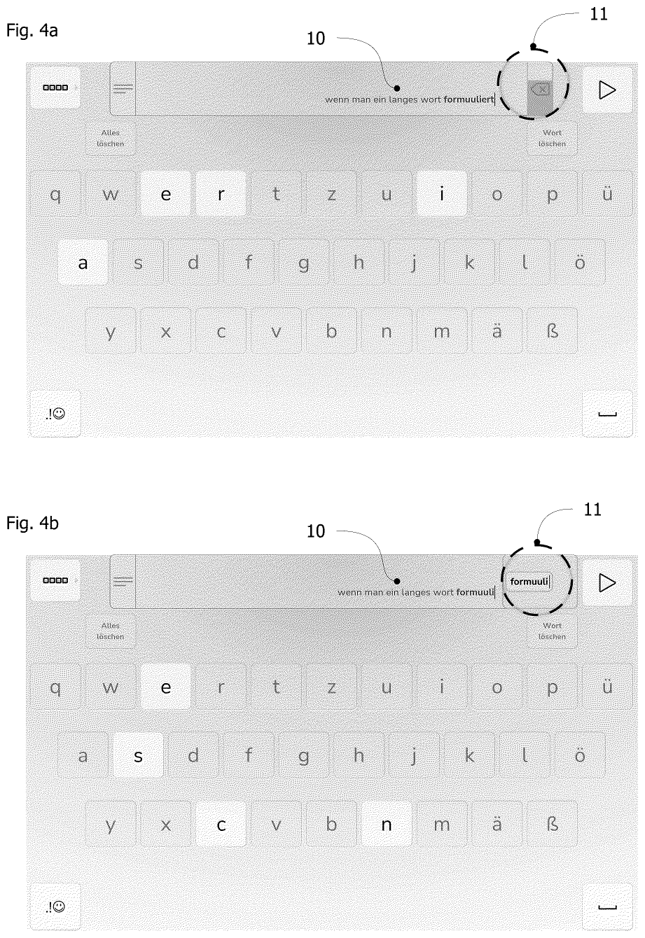

FIGS. 4a-4b show the deletion of letters according to a third exemplary embodiment of the method according to the invention; and

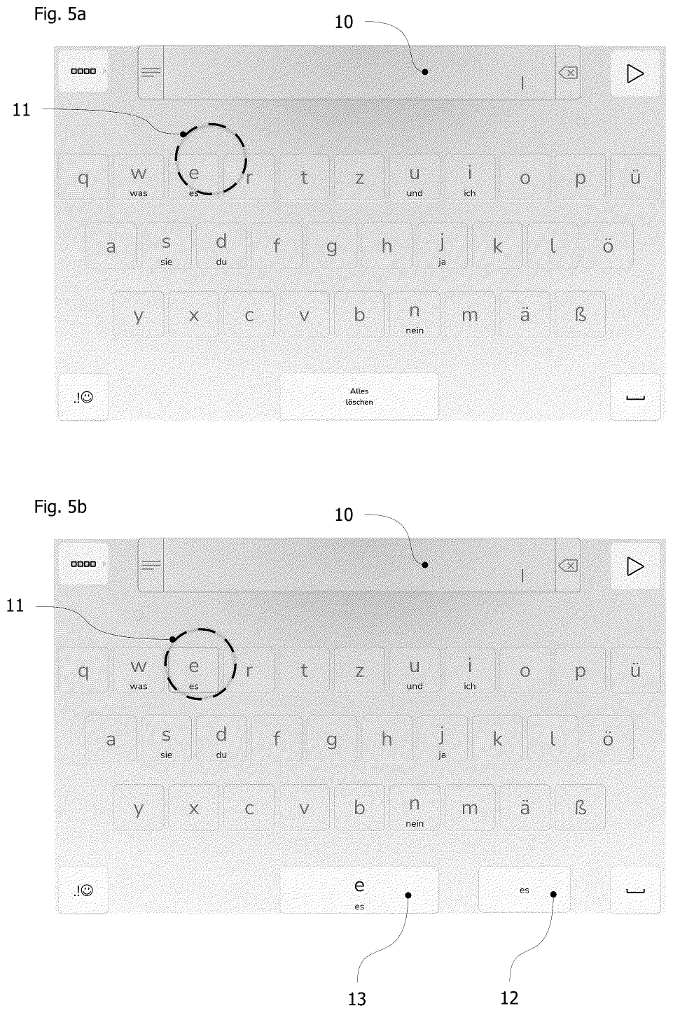

FIGS. 5a-5b show the generation of a second trigger button according to a fourth embodiment of the method according to the invention; and

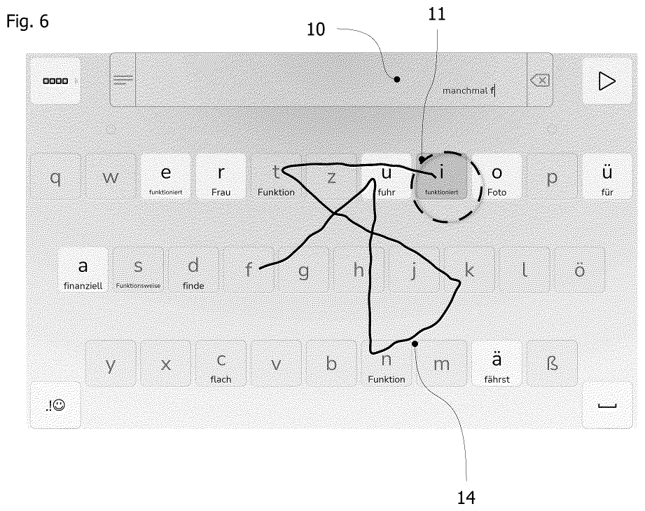

FIG. 6 shows the generation of word proposals in response to an input of a movement path according to a fifth embodiment of the method according to the invention.

The same reference numerals are used in the following description for identical and identically acting parts.

FIG. 1 schematically shows a device 20 according to the invention for a supported communication. The device 20 has a tablet computer 21 and an eye tracking camera 22 connected thereto.

The tablet computer 21 can in particular be a commercially available tablet computer with touch-sensitive screen. An operating system installed on the tablet computer 21 is formed to display an on-screen keyboard 1 with a plurality of buttons, by means of which in particular letters and other characters can be input or other actions can be triggered.

The eye tracking camera 22 is connected to the tablet computer 21, for example via a USB-C interface, and is directed at the face of a user of the tablet computer 21, which faces the screen area of the tablet computer 21. The eye tracking camera 22 is formed to detect a gaze position 11 of the user on the screen of the tablet computer 21, in particular in the area of the on-screen keyboard 1, and to provide it to the tablet computer 21.

The device 20 is formed to assign the gaze position 11 provided by the eye tracking camera 22 to a position on the screen, in particular to a button of the on-screen keyboard 1, so that the on-screen keyboard 1 (alternatively or additionally to the operation by touching the screen) can be operated via eye control.

The device 20 is thereby further formed to generate a modified on-screen keyboard according to the method according to the invention during the input process and to display it on the screen of the tablet computer 21, for example in the way as it is explained below in combination with the exemplary embodiments of FIGS. 2 to 5. For this purpose, the method according to the invention can be installed on the tablet computer 21 as software application.

A screen history, in the case of which a modified on-screen keyboard with word proposals according to the method according to the invention according to a first exemplary embodiment is generated, is illustrated in FIGS. 2a to 2e.

The FIGS. 2a to 2e each show an on-screen keyboard of a device, which can be operated via eye control. The on-screen keyboard has conventional buttons for the letters of the German alphabet as well as different functional buttons. A button is thereby triggered when it is detected that the gaze position 11 dwells within an area, which is assigned to the button, for at least the duration of a trigger threshold value. The portion of time, which has already passed, until the button is triggered, is thereby displayed to the user via the vertical progress bar, which is arranged within the focused button (see button of the letter “h” in FIG. 2a). A text field 10, in which the text input is displayed according to the currently input letters, is arranged in the upper area of the on-screen keyboard.

FIG. 2a hereby shows a state, in which the user has previously input the letter sequence “how are you” (German: “wie geht es dir”) and his/her current gaze position 11 lies in the area of the button “h”, in order to continue the letter sequence with the letter “h”.

FIG. 2b shows the modified on-screen keyboard, which, according to the invention, is generated and displayed immediately after triggering the button “h” in FIG. 2a.

A plurality of word proposals “today” (German: “heute”), “here” (German: “hier”), “hope” (German: “hoffnung”), “have” (German: “haben”), “hear” (German: “hören”) was furthermore determined, which are displayed in the modified on-screen keyboard within the button of the respective following letters “e”, “i”, “o”, “a” and “ö”. As can be seen in FIG. 2b, the word proposals are displayed directly in the buttons of the following letters, so that they are already displayed in the (future) focus area of the user when said user moves his/her gaze position 11 away from the letter “h” and focusses on the button of the desired following letter for continuing the input.

In that each word proposal is already displayed in advance in the corresponding button of the following letter, and not only when the device detects the focusing on the button of the following letter, a further delay in addition to the unavoidable delay is avoided, which is present due to the detection of the gaze position 11 by means of the eye tracking camera. In this way, the input speed can be increased for the user.

The word proposals were thereby determined on the basis of their statistical frequency, whereby not only the input prefix “h” but also the previous user inputs (“how are you t”—German: “wie geht es dir h”). For example, the word proposal “today” (German: “heute”) and not “bright” (German: “hell”) is thus displayed in the following letter “e” because the word sequence “how are you today” (German: “wie geht es dir heute”) has a higher statistical frequency than the word sequence “how are you bright” (German: “wie geht es dir hell”).

FIGS. 2c to 2e show the further input history and the correspondingly modified on-screen keyboards based on the state illustrated in FIG. 2b. After the user has directed his/her gaze position 11 to the button “e” with the word proposal “today” (German: “heute”), as illustrated in FIG. 2c, a trigger button 12 is illustrated on the one hand, as illustrated in FIG. 2d. If the user focusses on the trigger button 12, the input prefix “how are you to” (German: “wie geht es dir he”) is supplemented to “how are you today” (German: “wie geht es dir heute”) according to the word proposal “today” (German: “heute”) (see text field 10 in FIG. 2e).

The FIGS. 3a to 3c show the generation of inflections as word proposals according to a second exemplary embodiment of the method according to the invention. This takes place using the example of a keyboard, as it has been explained in combination with the exemplary embodiment of FIGS. 2a to 2e.

FIG. 3a hereby shows the state, in which the text field 10 is empty and the user has directed the gaze position 11 at the button of the letter “k”, in order to input this letter.

FIG. 3b shows the state, after “k” has been input and stands int eh text field 10, whereby word proposals (“can”—German: “kann”, “no”—German: “kein”, “can”—German: “können”, etc.) are displayed in the following letters, as it has been explained in combination with the exemplary embodiment of FIGS. 2a to 2e. In FIG. 3b, the user has directed his/her gaze position 11 at the button of the letter “ö”, which includes the word proposal “can” (German: “können”).

FIG. 3c shows the state according to FIG. 3b, after the letter “ö” has been input (see “kö” in the text field 10). According to the method according to the invention, it was recognized hereby that the verb “can” (German: “können”) is capable of inflection and generates corresponding inflections as word proposals:
“could” (German: “könnte”) in the button “e”;
“could” (German: “könntet”) in the button “t”;
“could” (German: “könntest”) in the button “s”; and
“can” (German: “können”) in the button “n”.

The acceptance of the word proposals by the user can thereby take place as it has been described in combination with FIGS. 2a to 2e.

It can furthermore be seen from FIG. 3c that further word proposals are additionally generated, which are not based on inflections of the root word (see “body”—German: “Körper” in the following letter “r”). In this respect, the present exemplary embodiment can readily be combined with the exemplary embodiment of FIGS. 2a to 2e.

FIGS. 4a to 4b show the modification of the on-screen keyboard when deleting letters according to a third exemplary embodiment of the method according to the invention.

FIG. 4a thus shows the state, in the case of which the user wants to correct a previously input text in the text field “when a long word is formulated” (German: “wenn man ein langes wort formuuliert”). For this purpose, the user has directed his/her gaze position 11 at the delete button of the displayed on-screen keyboard. As it has been described on the basis of FIG. 2a for the letter buttons, the delete button is also triggered only after the expiration of a corresponding dwell time on the button, which is visualized via the vertical progress bar within the button.

The state, after the user has already deleted the characters “t”, “r” and “e” from the end of the input text by continuing to linger his/her gaze position 11 on the delete button, is illustrated in FIG. 4b. Continuing to linger the gaze position 11 on the delete button would cause the deletion of the letter “i” of the word or of the rest of the word “formuula” (German: “formuuli”) next. This word or this rest of the word, respectively, is displayed within the delete button and thus in the area of the gaze position 11. It is thus not required for the user to direct his/her gaze position 11 away from the delete button and to direct it at the text field 10, in order to check whether the desired character has already been deleted.

FIGS. 5a to 5b show the generation of a second trigger button according to a fourth exemplary embodiment of the method according to the invention.

FIG. 5a in particular shows a state, in which the user has directed his/her gaze position 11 at the button of the letter “e”, in order to trigger said button. As soon as the gaze position 11 has remained on the button or on an area assigned to it, respectively, for at least the duration of preselection threshold value (for example, 200 ms, 300 ms or 500 ms), the button “e” is preselected (without it being triggered).

FIG. 5b shows a modified on-screen keyboard, which is generated according to the invention, for the preselected button “e”. A trigger button 13 for the preselected letter “e” is hereby arranged in the lower area of the on-screen keyboard. The trigger button 13 is thereby significantly larger than the button of letter the “e”, it has approximately three times the width. A trigger button 12 for the word proposal “es” is additionally arranged in the modified on-screen keyboard, as it has been described in combination with the exemplary embodiment of FIGS. 2a to 2e.

FIG. 6 shows the generation of word proposals in response to inputting a movement path according to a fifth embodiment of the method according to the invention.

According to this exemplary embodiment, a text input takes place by detecting a movement path via the on-screen keyboard, without the individual buttons being triggered by the user thereby, in that they are focused at least for the duration of a trigger threshold value.

The sketched movement path 14 corresponds to the gaze position movement path of a user, who focusses on the buttons “f”, “u”, “n”, “k”, “t” and “i” in the mentioned order in a continuous movement. Respective input prefixes (“f”, “fu”, “fun”, “funk”, “funkti”) are hereby detected continuously during the detection of the movement path 14 and word proposals are generated. The word proposals are illustrated within the buttons of the respective following letters, as it is shown, for example, in the exemplary embodiment of FIGS. 1a to 1e, namely continuously during the input of the movement path.

In the state shown in FIG. 6, the button of the letter “i”, at which the current gaze position 11 of the user lies, includes the word proposal “functions” (German: “funktioniert”). The user thus has the option of completing the input prefix to “functions” (German: “funktioniert”), in that he/she accepts the word proposal (for example by dwelling on the button “i” for a longer period of time), without having to complete the movement path 14 according to the complete word via “o”, “n”, “i”, “e”, “r”, “t”.

It should be noted at this point that all of the above-described parts, in each case on their own—also without features, which are additionally described in the respective context, even if they have not been explicitly identified individually as optional features in the respective context, e.g., by means of the use of: in particular, preferably, for example, e.g., optionally, round brackets, etc.—and in combination or any subcombination, are to be considered to be independent designs or further developments of the invention, respectively, as it is defined in particular in the introductory description as well as the claims. Deviations therefrom are possible. It should be noted concretely that the word in particular or round brackets do not characterize any features, which are mandatory in the respective context.

### List of Reference Numerals

1 on-screen keyboard
10 text field
11 gaze position
12 trigger button for word proposal
13 trigger button for preselected letters
14 movement path
20 device for a supported communication
21 tablet computer
22 eye tracking camera

1. A method for generating an optimized on-screen keyboard for a device (20), in particular device for a supported communication, wherein the device is formed to display an on-screen keyboard (1), which can be operated by a user by means of eye control, wherein the method has the following steps:
a) displaying an on-screen keyboard (1), which has a plurality of buttons, on the device (20);
b) receiving at least one user input with regard to the on-screen keyboard (1), in particular focusing on a button by means of eye control;
c) determining context information, at least based on the user input;
d) generating a modified on-screen keyboard based on the context information,
wherein the modified on-screen keyboard includes at least one modified information and/or action element, which is arranged in a focus area of the user; and
e) displaying the modified on-screen keyboard on the device (1).

2. The method according to claim 1,
characterized in that
step c) comprises an evaluation of an input prefix, which is specified by a sequence of previous user inputs and the user input,
and step d) comprises the following steps:
generating at least one word proposal based on the input prefix;
assigning the at least one word proposal to a button of the on-screen keyboard, wherein the button displays a following letter with regard to the input prefix and the word proposal,
wherein in step d), the at least one word proposal is displayed within the assigned button.

3. The method according to claim 1,
characterized in that
step c) comprises the following steps:
c1) evaluating a root word based on a sequence of previous user inputs;
c2) generating at least one word proposal, which specifies an inflection of the root word, in particular with regard to person, mode and/or gender;
c3) assigning the at least one word proposal to a button of the on-screen keyboard,
wherein the button displays a last or penultimate letter of the word proposal,
wherein in step d), the at least one word proposal is thereby illustrated within the assigned button.

4. The method according to claim 1,
characterized in that
the method further comprises the following steps:
detecting that, by means of eye control, the user focusses on a button, in which a word proposal is displayed;
providing a completion button (12) in the modified on-screen keyboard, preferably in a lower area thereof,
wherein the completion button (12) displays the word proposal and is formed to accept the word proposal upon selection.

5. The method according to claim 1,
characterized in that
a plurality of word proposals is generated;
the method further comprises a determination of a priority of the respective word proposal, wherein the priority is determined in particular as a function of a usage frequency in a language and/or discussion situation; and
that word proposal, which has the highest priority among all word proposals, which are assigned to the button, is displayed in a respective button, in which a word proposal is displayed.

6. The method according to claim 1,
characterized in that
the user input comprises the focusing on a delete button, and
the method further comprises the following steps:
determining a word, which will at least be partly deleted when continuing to focus on the delete button; and
displaying the word within the delete button.

7. The method according to claim 1,
characterized in that
step c) further comprises the following steps:
detecting environmental data, in particular voice, image and/or position data, from at least one sensor;
assigning the environmental data to at least one environment, in particular discussion context, discussion partner and/or location,
and step d) comprises the modification of at least one button based on the environmental data.

8. The method according to claim 1,
characterized in that
at least one language model, in particular a large language model, is used for
assigning the environmental data to at least one environment; and/or
generating word proposals, in particular based on the environment.

9. The method according to claim 1,
wherein step c) comprises a detection of a dwell time on a first button,
and the method further comprises the following steps:
determining whether the dwell time exceeds a preselection threshold value;
if the dwell time exceeds the preselection threshold value, generating the modified on-screen keyboard in such a way that the latter includes a second button (13),
wherein the second button (13) is configured to trigger an action, which is associated with the first button, in particular the input of a letter, which is displayed on the first button,
wherein the second button (13) is larger, preferably at least twice as large, as the first button, and
wherein the second button (13) is preferably arranged in a lower area of the modified on-screen keyboard.

10. The method according to claim 1,
wherein one or several buttons of the on-screen keyboard and of the modified on-screen keyboard are triggered by focusing on a respective area, which is larger than a visible boundary of the button and surrounds the visible boundary.

11. The method according to claim 1,
further comprising the following steps:
detecting a speed, with which a gaze position of the user moves over the on-screen keyboard;
modifying a trigger threshold of at least one button of the modified on-screen keyboard based on the speed, wherein the trigger threshold specifies a time, during which the button has to at least be focused on in order to be triggered.

12. The method according to claim 1,
wherein the detection of the at least one user input comprises a detection of a movement path over the on-screen keyboard,
and the determination of context information comprises a continuous determination of a current input prefix and corresponding word proposals during the input of the movement path
and wherein the word proposals are provided via the modified on-screen keyboard during the input of the movement path.

13. A computer-readable storage medium, which includes instructions, which prompt at least one processor to implement the method according to claim 1 when the instructions are executed by means of the at least one processor.

14. A device (20), in particular for a supported communication, which has the following:
a tablet computer (21), which is formed to display an on-screen keyboard (1);
an eye tracking camera (22), which is formed to detect a gaze position (11) with respect to the on-screen keyboard (1);
wherein the tablet computer (21) is further formed to receive the gaze position (11) from the eye tracking camera (21) and to carry out the method according to claim 1.

15. The device (20) according to claim 14,
characterized in that
the device (20) further has at least one of the following sensors: sound sensor, image sensor, GPS position sensor.
